(19) United States
(12) Patent Application Publication
(10) Pub. No.: US 2025/0392479 A1
(43) Pub. Date: Dec. 25, 2025

(54) INFORMATION PROCESSING APPARATUS USING ELECTRONIC CERTIFICATE, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: NAOKI TSUCHITOI, Kanagawa (JP)

(21) Appl. No.: 19/242,074

(22) Filed: Jun. 18, 2025

(30) Foreign Application Priority Data
Jun. 20, 2024 (JP) 2024-099542

(51) Int. Cl. H04L 9/32; H04L 9/14

(52) U.S. Cl. CPC H04L 9/3263; H04L 9/14

(57) ABSTRACT

An apparatus capable of preventing from setting an expiration date of an electronic certificate exceeding an imperilment time of an algorithm used for an electronic certificate issuing process. The apparatus including a memory device that stores a set of instructions, and at least one processor that executes the set of instructions to generate a key pair, generate an issue request for an electronic certificate that certifies legitimacy of the apparatus according to an instruction by a user, the issue request including a certificate signing request generated based on a public key included in the key pair, perform control to prevent a date exceeding an imperilment time of an algorithm used for an issue process for an electronic certificate from being included in the issue request as an expiration date of the electronic certificate, and obtain an electronic certificate generated according to the issue request.

### BACKGROUND

### Field of the Technology

The aspect of the embodiments relates to an information processing apparatus using an electronic certificate, a control method therefor, and a storage medium storing a control program therefor.

### Description of the Related Art

In order to perform network communication safely, an electronic certificate is used. An information processing apparatus transmits an issue request for an electronic certificate for certifying its own legitimacy to a certificate authority that is a third party organization, and holds the electronic certificate issued by the certificate authority (for example, see Japanese Patent Laid-Open No. 2018-139369). The information processing apparatus transmits the electronic certificate to a communication partner apparatus. The communication partner apparatus verifies legitimacy of the information processing apparatus using the received electronic certificate.

An algorithm used for an electronic certificate issuing process cannot maintain designed encryption strength after a certain time period due to improvement of calculation capability of a computer and development of an efficient analysis method. This is called imperilment. An imperilment time of each algorithm is defined by public organizations, such as NIST and Cryptrec.

On the other hand, when an electronic certificate for certifying legitimacy of an information processing apparatus is issued, a user who operates the information processing apparatus designates an expiration date of the electronic certificate. However, the user sometimes designates the expiration date of the electronic certificate exceeding the imperilment time of the algorithm unintentionally. As a result, the electronic certificate with the expiration date exceeding the imperilment time of the algorithm is issued. Such an electronic certificate increases risk of falsification after exceeding the imperilment time even before the expiration date, and thus, cannot achieve secure network communication.

### SUMMARY

Accordingly, an aspect of the embodiments provides an apparatus including a memory device that stores a set of instructions, and at least one processor that executes the set of instructions to generate a key pair, generate an issue request for an electronic certificate that certifies legitimacy of the apparatus according to an instruction by a user, the issue request including a certificate signing request generated based on a public key included in the key pair generated, perform control to prevent a date exceeding an imperilment time of an algorithm used for an issue process for an electronic certificate from being included in the issue request as an expiration date of the electronic certificate, and obtain an electronic certificate generated according to the issue request.

Features of the disclosure will become apparent from the following description of embodiments with reference to the attached drawings. The following description of embodiments are described by way of example.

### BRIEF DESCRIPTION OF THE DRAWINGS

FIG. 1 is a configuration view illustrating a network including a multifunction peripheral as an information processing apparatus in a first embodiment.

FIG. 2 is a schematic view illustrating an example of an electronic certificate used by the multifunction peripheral in FIG. 1.

FIG. 3 is a block diagram schematically illustrating a hardware configuration of the multifunction peripheral in FIG. 1.

FIG. 4 is a block diagram schematically illustrating a software configuration of the multifunction peripheral in FIG. 1.

FIG. 5 is a sequence diagram illustrating a flow of a series of processes of issuing an electronic certificate and registering the electronic certificate in the first embodiment.

FIG. 6 is a view illustrating an example of an electronic certificate issue request screen in the first embodiment.

FIG. 7 is a flowchart illustrating procedures of an issue request generation process in S504 in FIG. 5.

FIG. 8 is a flowchart illustrating procedures of an expiration date determination process in S710 in FIG. 7.

FIG. 9A is a view illustrating an example of management data stored in a ROM in FIG. 3.

FIG. 9B is a view illustrating another example of the management data stored in the ROM in FIG. 3.

FIG. 10 is a flowchart illustrating procedures of the electronic certificate registration process in S507 in FIG. 5.

FIG. 11A is a table illustrating a configuration example of a databased stored in an HDD in FIG. 3.

FIG. 11B is a table illustrating a configuration example in which data is added to the database illustrated in FIG. 11A.

FIG. 11C is a table illustrating a configuration example in which the database illustrated in FIG. 11B is updated.

FIG. 12A is a view illustrating an example of a screen displayed based on HTML data generated in the electronic certificate registration process in FIG. 10 when the electronic certificate is successfully obtained.

FIG. 12B is a view illustrating an example of a screen displayed based on the HTML data generated in the electronic certificate registration process in FIG. 10 when the obtainment of the electronic certificate fails.

FIG. 13 is a flowchart illustrating procedures of a reboot process in S510 in FIG. 5.

FIG. 14 is a view illustrating an example of a screen displayed based on HTML data generated in S1302 in FIG. 13.

FIG. 15 is a view illustrating an example of an update reservation setting screen in a second embodiment.

FIG. 16 is a flowchart illustrating procedures of an electronic certificate reservation update control process in the second embodiment executed by the multifunction peripheral in FIG. 1.

FIG. 17 is a view illustrating an example of a setting screen in a third embodiment to set an operation policy applied when the expiration date exceeds an imperilment time.

FIG. 18 is a view illustrating an example of an error screen in the third embodiment.

### DESCRIPTION OF THE EMBODIMENTS

Hereinafter, details of embodiments of the disclosure will be described with reference to the attached drawings. A digital multifunction peripheral (digital MFP) is taken as an example of an information processing apparatus that uses and manages an electronic certificate in the embodiments. However, the scope of application of the disclosure is not limited to a multifunction peripheral, and may be any apparatus that can use an electronic certificate.

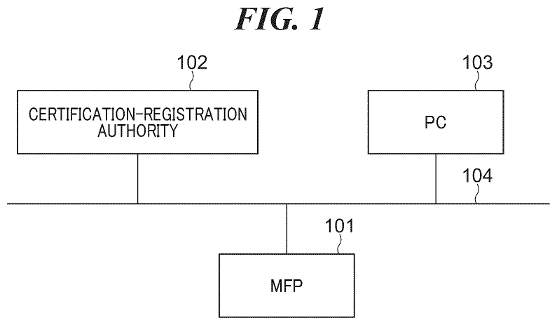

First, the information processing apparatus and its control method in a first embodiment of the disclosure will be described. FIG. 1 is a configuration view illustrating a network including the multifunction peripheral 101 as the information processing apparatus in the embodiment.

As shown in FIG. 1, the multifunction peripheral 101 performs data communication with a certification-registration authority 102 and a personal computer (PC) 103 via a network 104. The multifunction peripheral 101 can also transmit and receive print data, image data obtained by scanning, and management information about a device to and from another information processing apparatus via the network 104. The multifunction peripheral 101 has a function of performing encrypted communications, such as TLS, IPSEC, and IEEE802.1X, and holds a key pair and an electronic certificate used for these encryption processes. In the disclosure the key pair means a combination of a public key and a corresponding secret key. The electronic certificate is a certificate for certifying legitimacy of the multifunction peripheral 101 and is issued by the certification-registration authority 102.

The certification-registration authority 102 functions as a server having a function of a certification authority (CA) that issues an electronic certificate and a function of a registration authority (RA) that accepts an issue request for an electronic certificate and registers an electronic certificate.

The certification-registration authority 102 has a function of distributing a CA certificate via the network 104. A CA certificate certifies legitimacy of an electronic certificate. The certification-registration authority 102 has a function of issuing and registering an electronic certificate. When this function is used, an SCEP (Simple Certificate Enrollment Protocol) shall be employed as a protocol on the network in the embodiment. The information processing apparatus such as the multifunction peripheral 101 communicates with the certification-registration authority 102 to obtain an electronic certificate via the network 104 by using the SCEP. The multifunction peripheral 101 in the embodiment has a web server function, and publishes a webpage type remote UI (RUI) function capable of issuing an instruction to issue an electronic certificate on the network 104.

When receiving an issue request for an electronic certificate from the information processing apparatus such as the multifunction peripheral 101 via the network 104, the certification-registration authority 102 issues and registers the electronic certificate based on the issue request, and transmits the electronic certificate to the information processing apparatus. Although the configuration in which the function of the certificate authority and the function of the registration authority operate in the same server is described in the embodiment, the function of the certificate authority and the function of the registration authority may operate in different servers. In addition, although the configuration in which the SCEP is used as the protocol in using the function of distributing a CA certificate or issuing and registering an electronic certificate via the network 104 is described in the embodiment, the protocol used at this time is not limited to the SCEP, and another protocol having a function equivalent to the SCEP may be used. The other protocol may be a CMP (Certificate Management Protocol) or an EST (Enrollment over Secure Transport) protocol.

The PC 103 is equipped with a Web browsing function and is capable of browsing and using HTML documents and Web sites published by the information processing apparatus such as the multifunction peripheral 101 connected to the network 104.

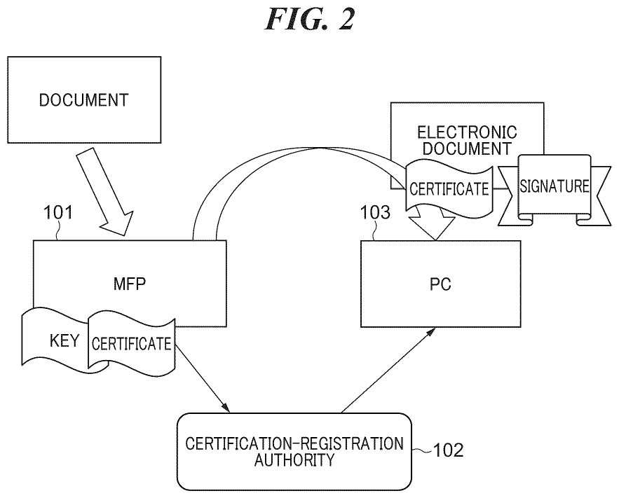

Next, an example of use of an electronic certificate in the multifunction peripheral 101 will be described. FIG. 2 is a schematic view illustrating an example of an electronic certificate used by the multifunction peripheral 101 in FIG. 1. As shown in FIG. 2, the multifunction peripheral 101 holds a key pair and an electronic certificate that are unique to the device. The electronic certificate shall be signed by the certification-registration authority 102. The multifunction peripheral 101 scans a paper document and generates an electronic document of the paper document. The electronic document is image data in an existing data format such as a PDF format. The multifunction peripheral 101 generates a signature using a secret key of a generated key pair held by the multifunction peripheral 101, and adds the generated signature and the electronic certificate to the electronic document.

When receiving the electronic document, the PC 103 confirms the signature of the electronic document. A root certificate to certify legitimacy of the CA certificate is incorporated in advance in an OS of the PC 103, and the PC 103 verifies the signature using this root certificate. This enables to verify whether the electronic certificate attached to the electronic document is signed by the certification-registration authority 102. The PC 103 can certify that the electronic document generated by scanning with the multifunction peripheral 101 has not been falsified by verification using the signature and the electronic certificate attached to the electronic document.

Next, an overview of a process to obtain and update an electronic certificate in the embodiment will be described.

An administrator of the multifunction peripheral 101 accesses a webpage published by the multifunction peripheral 101 using a web browser installed in the PC 103, and instructs to issue an electronic certificate on the webpage. The multifunction peripheral 101 requests the certification-registration authority 102 to issue an electronic certificate according to the SCEP in accordance with a content of the instruction input by the administrator. The multifunction peripheral 101 obtains the electronic certificate included in a response to the issue request, that is, the electronic certificate issued by the certification-registration authority 102, and sets a usage of the electronic certificate obtained. Details of the usage setting of the electronic certificate will be described later.

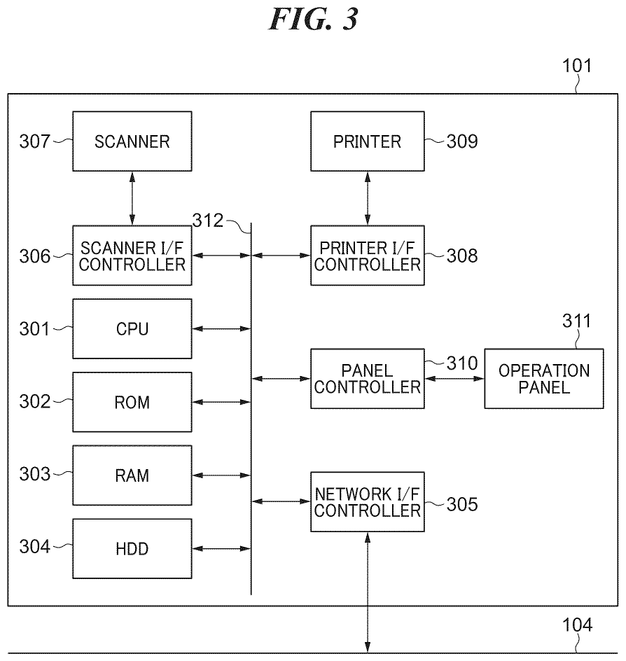

Next, the configuration of the multifunction peripheral 101 will be described. FIG. 3 is a block diagram schematically illustrating a hardware configuration of the multifunction peripheral 101 in FIG. 1. As shown in FIG. 3, the multifunction peripheral 101 includes a CPU 301, a ROM 302, a RAM 303, an HDD 304, a network I/F controller 305, a scanner I/F controller 306, a scanner 307, a printer I/F controller 308, a printer 309, a panel controller 310, and an operation panel 311. The CPU 301, ROM 302, RAM 303, HDD 304, network I/F controller 305, scanner I/F controller 306, printer I/F controller 308, and panel controller 310 are communicably connected to each other via a bus 312.

The CPU 301 executes a software program of the multifunction peripheral 101 and controls the entire multifunction peripheral 101. The ROM 302 is a read-only memory that stores a boot program and fixed parameters for the multifunction peripheral 101. The RAM 303 is a random access memory that is used when the CPU 301 temporarily stores various data for controlling the multifunction peripheral 101. The HDD 304 is a hard disk drive that stores system software, applications, and various data.

The network I/F controller 305 controls transmission and reception of the data to and from an external apparatus via the network 104. The scanner I/F controller 306 controls the scanner 307. The scanner 307 reads a document and generates image data of the document. The printer I/F controller 308 controls the printer 309. The printer 309 performs printing based on print data received from the printer I/F controller 308. The panel controller 310 controls the operation panel 311 of a touch panel type, displays various information, and obtains an instruction input by a user through the operation panel 311.

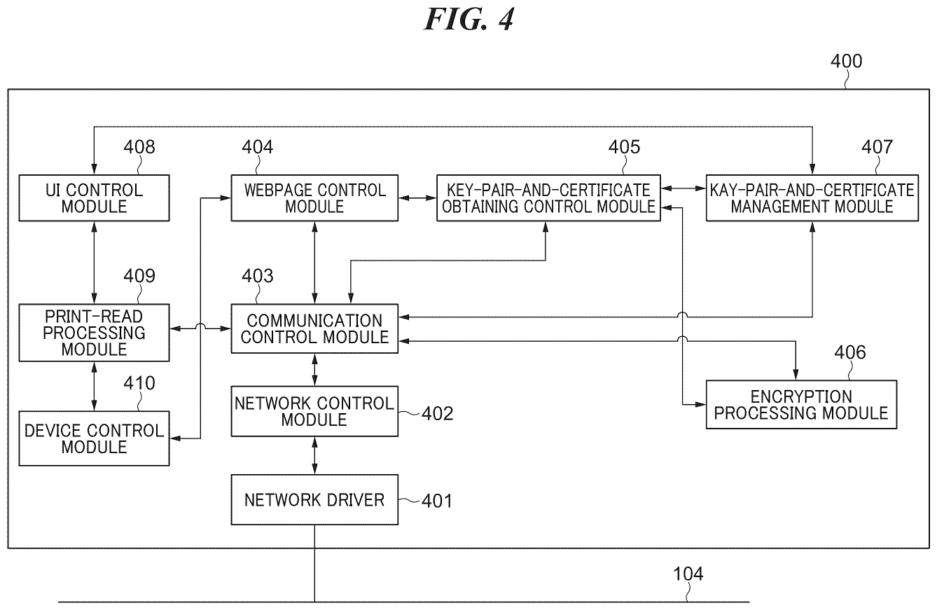

FIG. 4 is a block diagram schematically illustrating a software configuration of the multifunction peripheral 101 in FIG. 1. As shown in FIG. 4, the multifunction peripheral 101 includes, as software modules, a network driver 401, a network control module 402, a communication control module 403, a webpage control module 404, a key-pair-and-certificate obtaining control module 405, an encryption processing module 406, a key-pair-and-certificate management module 407, an UI control module 408, a print-read processing module 409, and a device control module 410. The controller including these software modules is hereinafter referred to as a controller 400. In this specification, the controller 400 is configured by the CPU 301, ROM 302, RAM 303, HDD 304, etc. The program to execute the following flowcharts is stored in a memory that is any one of the ROM 302, RAM 303, and HDD 304 of the controller 400, and is executed by the CPU 301.

The network driver 401 controls the network I/F controller 305 to control data communication with an external device via the network 104. The network control module 402 controls communication in a transport layer or lower in a network communication protocol such as TCP/IP, and transmits and receives data. The communication control module 403 controls a plurality of communication protocols supported by the multifunction peripheral 101. In the process to obtain and update an electronic certificate in the embodiment, the communication control module 403 controls a process to generate and analyze a request and response data for HTTP protocol communication and transmission and reception of data, thereby achieving the communication with the certification-registration authority 102 and the PC 103. Further, the communication control module 403 also achieves encrypted communication of TLS, IPSEC, and IEEE802.1X supported by the multifunction peripheral 101.

The webpage control module 404 controls generation of HTML data of a webpage for instructing issue of an electronic certificate and controls transmission of the HTML data to an external apparatus such as the PC 103. The webpage controller 404 executes a process corresponding to a webpage display request received by the network driver 401 from an external apparatus. For example, the webpage control module 404 outputs, as a response to the display request, HTML data of webpages stored in the RAM 303 or the HDD 304 or HTML data generated according to the content of the display request, in accordance with the received webpage display request.

The key-pair-and-certificate obtaining control module 405 executes an electronic certificate obtaining process in accordance with the instruction received from the webpage control module 404. The key-pair-and-certificate obtaining control module 405 controls communication according to the SCEP, executes a process to generate and analyze encrypted data, which is defined by PKCS #7 or PKCS #10, for communication according to the SCEP, stores the obtained electronic certificate, and sets its usage.

The encryption processing module 406 executes various types of encryption processes, such as a data encryption-decryption process, a signature generation-verification process, and a hash value generation process. In the process to obtain and update the electronic certificate in the embodiment, the encryption processing module 406 executes encryption processes for the process to generate and analyze the request and response data according to the SCEP.

The key-pair-and-certificate management module 407 manages the key pair and the electronic certificate held by the multifunction peripheral 101. The key pair and the electronic certificate are stored in the RAM 303 or the HDD 304 together with various set values. Further, processes, such as detailed display, generation, and deletion of the key pair and the electronic certificate, can be executed in accordance with an instruction by a user operation on the operation panel 311. In the embodiment, in the encrypted communication process of TLS, IPSEC, or IEEE802.1X executed by the communication control module 403, the encryption processing module 406 obtains the key pair and the electronic certificate used in the encrypted communication process from the key-pair-and-certificate management module 407.

The UI control module 408 controls the operation panel 311 and the panel controller 310. The print-read processing module 409 achieves functions such as printing with the printer 309 and image reading with the scanner 307. The device control module 410 generates a control command and control data for the multifunction peripheral 101 and totally controls the multifunction peripheral 101. For example, the device control module 410 controls power supply of the multifunction peripheral 101 and executes a reboot process of the multifunction peripheral 101 in accordance with an instruction received from the webpage control module 404.

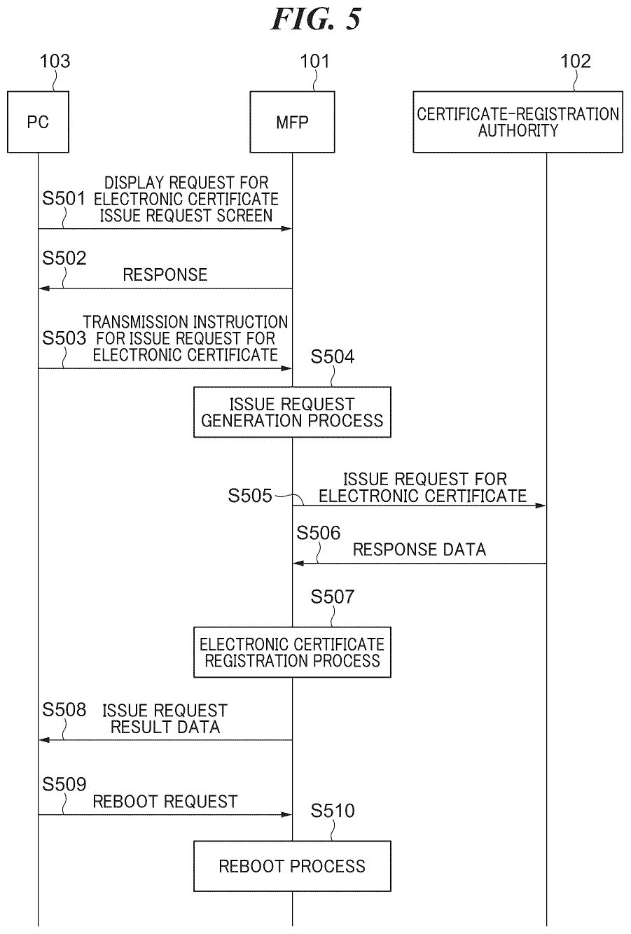

FIG. 5 is a sequence diagram illustrating a flow of a series of processes of issuing an electronic certificate and registering the electronic certificate in the embodiment.

In S501 in FIG. 5, the PC 103 first transmits a display request for an electronic certificate issue request screen to the multifunction peripheral 101. In the embodiment, the administrator of the multifunction peripheral 101 shall connect to a web-page-format RUI published by the multifunction peripheral 101 using the web browser installed in the PC 103 and input various instructions related to the issue of an electronic certificate to the RUI. In S501, the PC 103 transmits the display request for the electronic certificate issue request screen to the multifunction peripheral 101 in accordance with the instruction input to the RUI by the administrator of the multifunction peripheral 101.

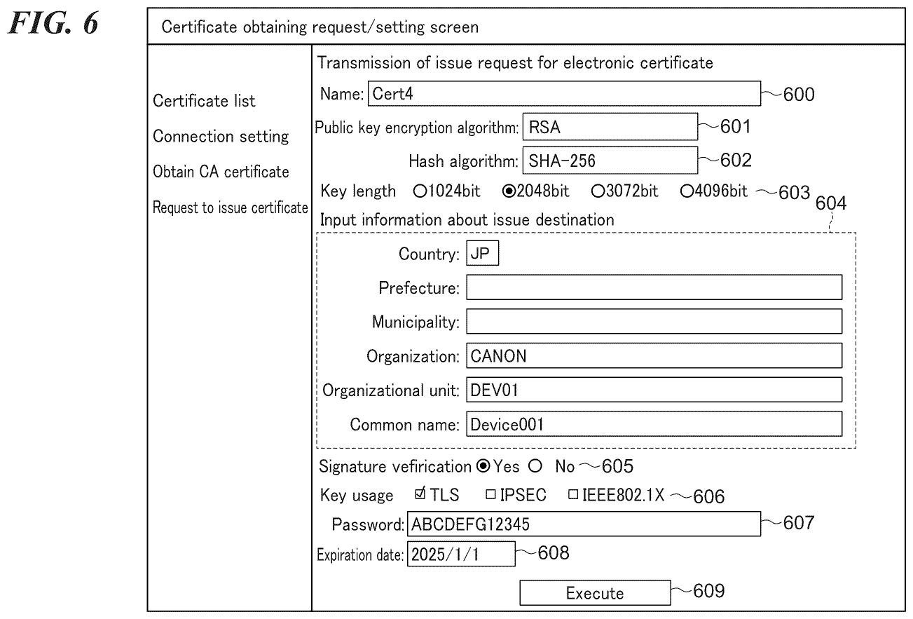

Next, the controller 400 of the multifunction peripheral 101 transmits in S502 HTML data to display the electronic certificate issue request screen shown in FIG. 6 to the PC 103 as a response to the display request received from the PC 103. The PC 103 displays the electronic certificate issue request screen shown in FIG. 6 on the display unit of the PC 103 based on the received HTML data.

The electronic certificate issue request screen shown in FIG. 6 includes a name field 600, a public key encryption algorithm field 601, a hash algorithm field 602, key length radio buttons 603, issue destination information input fields 604, signature inspection radio buttons 605, key usage check boxes 606, a password field 607, an expiration date field 608, and an execution button 609.

In the name field 600, an arbitrary character string registered in association with the generated key pair and the information about the electronic certificate is input. A public key encryption algorithm used to generate a key pair is input to the public key encryption algorithm field 601. A hash algorithm used to generate a key pair is input to the hash algorithm field 602. Although FIG. 6 shows the configuration in which an algorithm used to generate a key pair and an algorithm used to generate a hash value are input as character strings into the public key encryption algorithm field 601 and the hash algorithm field 602, this is not limited. For example, these may be configured by radio buttons or check boxes so as to cause a user to select one of a plurality of algorithms that can be used by the multifunction peripheral 101.

The key length of the key pair to be generated is selected from among the key length radio buttons 603. Information about the issue destination of the electronic certificate is input to the issue destination information input fields 604. The signature verification radio buttons 605 are used to set whether to verify a signature given to a response transmitted from the certification-registration authority 102. The usage of the issued electronic certificate is selected from among the key usage check boxes 606. In the embodiment, the encrypted communication can be selected from among TLS, IPSEC, and IEEE802.1X by using the key usage check boxes 606. A password to be included in the issue request for the electronic certificate is input to the password field 607. An expiration date of the electronic certificate to be issued is input to the expiration date field 608. The expiration date is the end of a valid period of the electronic certificate. Although the algorithm used to generate the key pair and the expiration date of the electronic certificate are set on the electronic certificate issue request screen in FIG. 6 in the embodiment, these may be set on another screen. The execution button 609 is used to instruct transmission of an issue request for an electronic certificate.

When the administrator of the multifunction peripheral 101 clicks the execution button 609, the PC 103 transmits a transmission instruction for an issue request for an electronic certificate to the multifunction peripheral 101 in S503. The transmission instruction includes set values set on the electronic certificate issue request screen in FIG. 6. When the algorithm used to generate the key pair and the expiration date of the electronic certificate are set on a screen other than the electronic certificate issue request screen in FIG. 6, the transmission instruction includes the algorithm used to generate the key pair and the expiration date of the electronic certificate set by the administrator of the multifunction peripheral 101 in addition to the set values set on the electronic certificate issue request screen in FIG. 6.

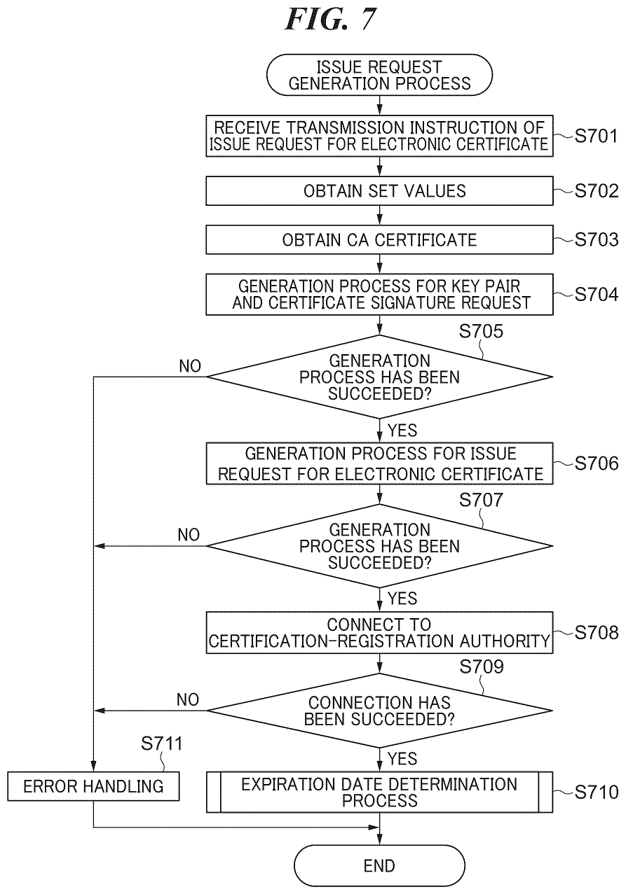

Next, the controller 400 of the multifunction peripheral 101 performs in S504 an issue request generation process in FIG. 7, which will be described later, in accordance with the received transmission instruction, and generates an issue request for an electronic certificate. The issue request for the electronic certificate is a message in a PKCS #7 format defined by the SCEP.

Next, the controller 400 transmits in S505 by a GET method or a POST method of the HTTP protocol the issue request for the electronic certificate generated in S504 to the certification-registration authority 102, which is an SCEP server, based on the address information set in advance.

Next, the certification-registration authority 102 transmits a response data to the received issue request to the multifunction peripheral 101 in S506. The response data includes the electronic certificate signed by the certification-registration authority 102.

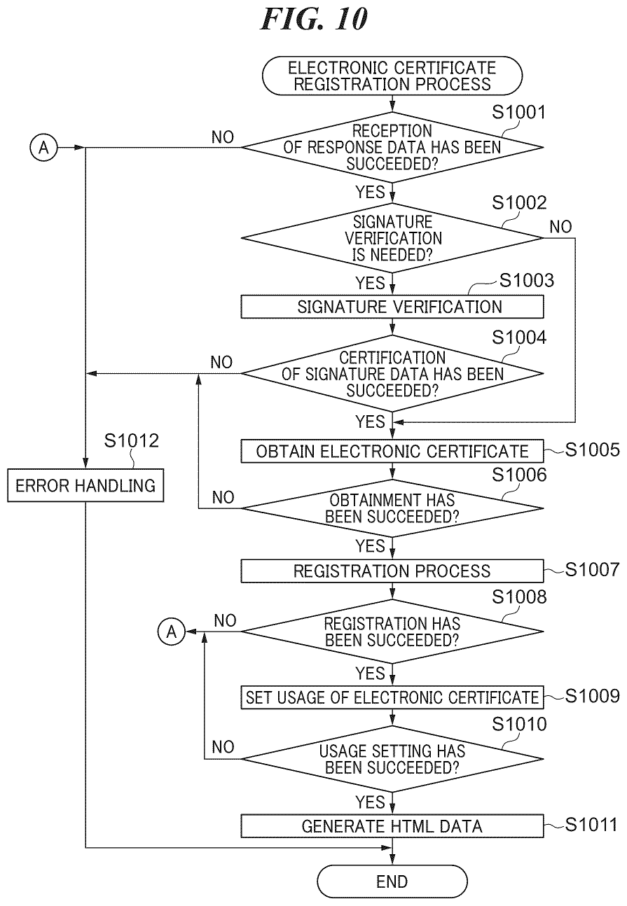

The controller 400 of the multifunction peripheral 101 that has received the response data performs in S507 an electronic certificate registration process in FIG. 10, which will be described later, registers the electronic certificate issued by the certification-registration authority 102, and generates issue request result data, which is result data corresponding to the issue request. The issue request result data corresponding to the issue request is HTML data to display a webpage screen indicating whether the electronic certificate has been successfully obtained.

Then, the controller 400 transmits the issue request result data generated in S507 to the PC 103 in S508. The communication control module 403 in the embodiment obtains the electronic certificate used for the encrypted communication such as IEEE802.1X at the time of activation of the multifunction peripheral 101. Therefore, reboot of the multifunction peripheral 101 is performed in order for the communication control module 403 to obtain the electronic certificate newly issued by the certification-registration authority 102.

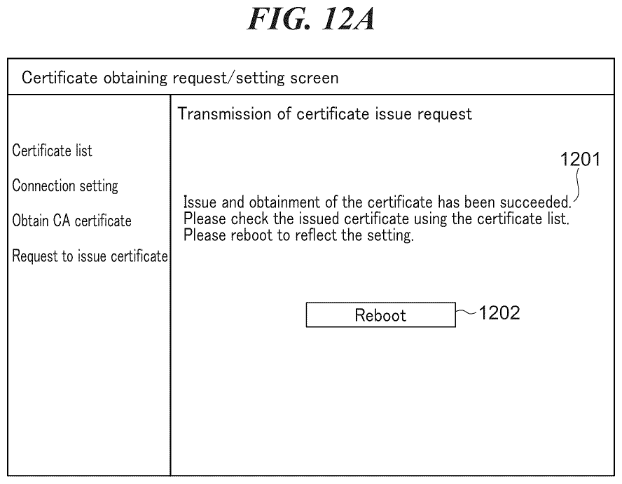

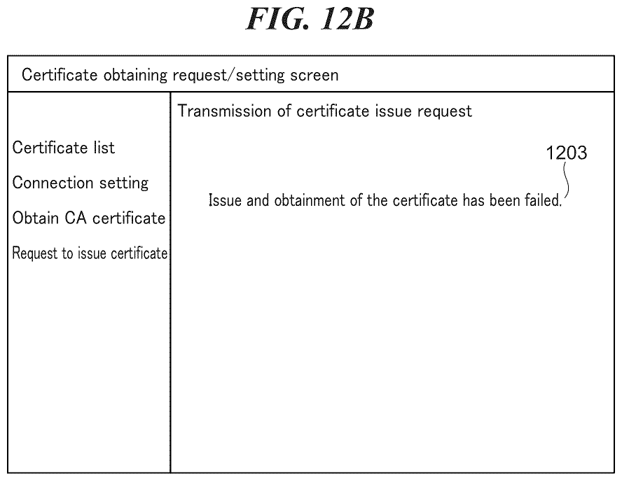

When the administrator of the multifunction peripheral 101 clicks a reboot button 1202 in FIG. 12A described later, the PC103 transmits a reboot request to the multifunction peripheral 101 in S509.

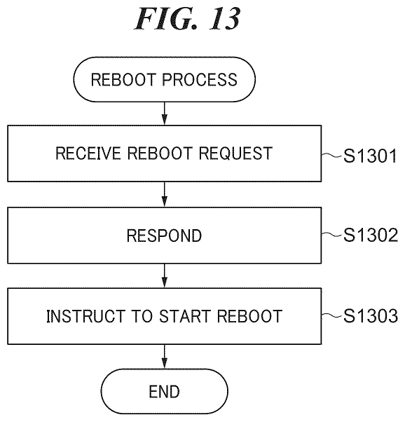

When receiving the reboot request, the controller 400 of the multifunction peripheral 101 performs in S510 a reboot process in FIG. 13, which will be described later. Thereafter, this process is ended.

FIG. 7 is a flowchart illustrating procedures of the issue request generation process executed in S504 in FIG. 5. In the embodiment, the multifunction peripheral 101 shall hold in advance a CA certificate for certifying the legitimacy of the electronic certificate distributed by the certification-registration authority 102 in the HDD 304.

As shown in FIG. 7, the controller 400 first receives the transmission instruction of the issue request for the electronic certificate in S701. As described above, the transmission instruction includes the set values set on the issue request for the electronic certificate screen in FIG. 6. Next, the controller 400 obtains in S702 the set values included in the transmission instruction received in S701. Next, the controller 400 obtains in S703 the CA certificate for certifying the legitimacy of the electronic certificate from the HDD 304.

Next, the controller 400 performs in S704 a process to generate a key pair and a CSR (Certificate Signing Request) in a PKCS #10 (Certification Request Syntax Specification) format defined in RFC2986 with the encryption processing module 406. The key pair is generated based on the set value input in the name field 600, the set value input in the public-key encryption algorithm field 601, and the set value selected by the key length radio buttons 603 obtained in S702. The certificate signing request is generated based on the generated public keys, the set values input in the issue destination information input fields 604, and the set value input in the password field 607 obtained in S702.

Then, the controller 400 determines in S705 whether the key pair and the certificate signing request are successfully generated. If it is determined that the generation of the key pair and the certificate signing request has been failed, the process proceeds to S711, which will be described later. When it is determined that the generation of the key pair and the certificate signing request has been succeeded, the process proceeds to S706.

In S706, the controller 400 performs an issue request generation process to generate an issue request for an electronic certificate. The issue request for the electronic certificate includes the certificate signing request generated in S704 and the set values obtained in S702. As described above, the issue request for the electronic certificate is the message in the PKCS #7 format defined by the SCEP. Next, the controller 400 determines in S707 whether the issue request for the electronic certificate has been successfully generated. When it is determined that the generation of the issue request for the electronic certificate has been failed, the process proceeds to S711, which will be described later. When it is determined that the generation of the issue request for the electronic certificate has been succeeded, the process proceeds to S708.

In S708, the controller 400 connects to the certification-registration authority 102, which is the SCEP server, with the TCP/IP. Then, the controller 400 determines in S709 whether the connection with the certification-registration authority 102 has been succeeded. In a case where it is determined that the connection with the certification-registration authority 102 has been failed, the process proceeds to S711 described later. When it is determined that the connection with the certification-registration authority 102 has been succeeded, the process proceeds to S710.

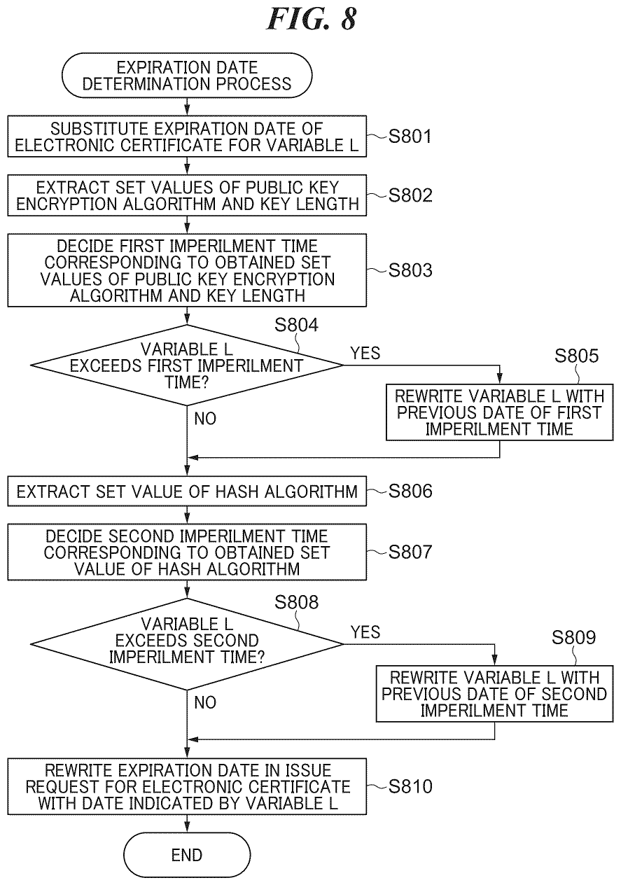

In S710, the controller 400 performs an expiration date determination process in FIG. 8 described later, and controls to prevent a date exceeding an imperilment time of the algorithm used for the electronic certificate issuing process from being included in the issue request for the electronic certificate as an expiration date of the electronic certificate. Thereafter, this process is ended.

In S711, the controller 400 performs error handling. In the error process, HTML data to display a webpage screen including a message indicating an occurrence of an error is transmitted to the PC 103. Thereafter, this process is ended.

Hereinafter, the imperilment will be described. The algorithm used for the electronic certificate issuing process cannot maintain designed encryption strength after a certain time period due to improvement of calculation capability of a computer and development of an efficient analysis method. This is called imperilment. It is dangerous to continue using the imperiled algorithm, and imperilment time is determined for each algorithm by NIST SP 800-57 in the United States, Japanese CRYPTREC, or the like. For example, it is said that a signature by the RSA public key encryption method with key length 2048 bits will be imperiled in 2031.

When issuing the electronic certificate of the multifunction peripheral 101, the administrator of the multifunction peripheral 101 designates the expiration date of the electronic certificate on the electronic certificate issue request screen in FIG. 6. However, the administrator may designate the expiration date of the electronic certificate exceeding the imperilment time of the algorithm unintentionally. As a result, an electronic certificate with an expiration date exceeding the imperilment time of the algorithm may be issued. Such an electronic certificate increases risk of falsification after exceeding the imperilment time even before the expiration date, and thus, cannot achieve secure network communication. In order to achieve secure network communication, it is necessary to control so that a date exceeding the imperilment time of the algorithm is not set as the expiration date of the electronic certificate.

In contrast, in the embodiment, the expiration date determination process in FIG. 8 is performed to prevent a date exceeding the imperilment date of the algorithm used for the electronic certificate issuing process from being included in the issue request for the electronic certificate as the expiration date of the electronic certificate.

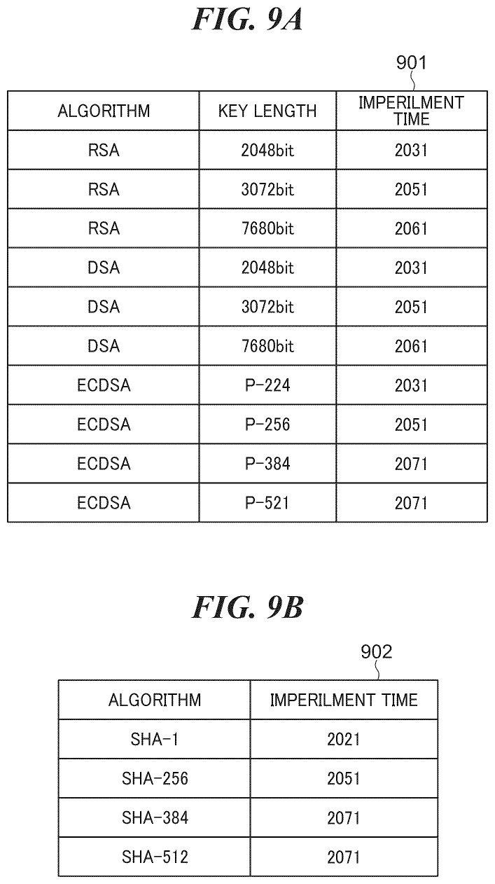

FIG. 8 is a flowchart illustrating procedures of the expiration date determination process executed in S710 in FIG. 7. In the embodiment, management data 901 in FIG. 9A and management data 902 in FIG. 9B shall be stored in the ROM 302 in advance. In the management data 901, an imperilment time of an algorithm selectable as a public key encryption algorithm used to issue a key pair is recorded for each key length. In the management data 902, imperilment times of algorithms selectable as a hash algorithm used to issue a key pair are recorded. Contents recorded in the management data 901 and the management data 902 are defined and updated by a public organization such as NIST or CRYPTREC.

In S801 in FIG. 8, the controller 400 extracts the set value input in the expiration date field 608 from the issue request for the electronic certificate generated in S706 and substitutes the extracted set value into a variable L.

Next, the controller 400 extracts in S802 the set value input in the public key encryption algorithm field 601 and the set value selected by the key length radio buttons 603 from the issue request for the electronic certificate generated in S706.

Next, the controller 400 determines in S803 a first imperilment time corresponding to the set value in the public key encryption algorithm field 601 and the set value selected by the key length radio buttons 603 obtained in S802 using the management data 901 stored in the ROM 302. For example, when the set value in the public key encryption algorithm field 601 is “RSA” and the set value selected by the key length radio buttons 603 is “2048 bits”, the first imperilment time is determined to be “2031” in S803.

Then, the controller 400 determines in S804 whether the variable L exceeds the first imperilment time. When it is determined that the variable L exceeds the first imperilment time, the process proceeds to S805. When it is determined that the variable L does not exceed the first imperilment time, the process proceeds to S806.

In S805, the controller 400 rewrites the variable L to the date one day before the first imperilment time. For example, when the first imperilment time is “2031”, the controller 400 rewrites the variable L to “Dec. 31, 2030”. Next, the controller 400 extracts in S806 the set value in the hash algorithm field 602 from the issue request for the electronic certificate generated in S706.

Next, the controller 400 determines in S807 a second imperilment time corresponding to the set value in the hash algorithm field 602 obtained in S806 using the management data 902 stored in the ROM 302. For example, when the set value in the hash algorithm field 602 is “SHA-256”, the second imperilment time is determined to be “2051” in S807.

Then, the controller 400 determines in S808 whether the variable L exceeds the second imperilment time. When it is determined that the variable L exceeds the second imperilment time, the process proceeds to S809. When it is determined that the variable L does not exceed the second imperilment time, the process proceeds to S810.

In S809, the controller 400 rewrites the variable L to the date one day before the second imperilment time. For example, when the second imperilment time is “2051”, the controller 400 rewrites the variable L to “Dec. 31, 2050”. Next, the controller 400 rewrites in S810 the expiration date in the issue request for the electronic certificate to the date of the variable L. Thereafter, this process is ended.

FIG. 10 is a flowchart illustrating procedures of the electronic certificate registration process executed in S507 in FIG. 5.

As shown in FIG. 10, the controller 400 first determines in S1001 whether the response data transmitted by the certification-registration authority 102 in response to the issue request for the electronic certificate is successfully received. The response data is defined by the SCEP and is in the PKCS #7 format. When it is determined that the reception of the response data has been failed, the process proceeds to S1012 described later. When it is determined that the response data has been successfully received, the process proceeds to S1002.

In S1002, the controller 400 determines whether verification of the digital signature is needed based on the set value selected by the signature verification radio buttons 605 obtained in S702 described above. When it is determined not to verify the digital signature, the process proceeds to S1005, which will be described later. When it is determined to verify the digital signature, the process proceeds to S1003.

In S1003, the controller 400 performs the signature verification. Specifically, the controller 400 verifies the signature data assigned to the response data received in S1001 by using the public keys included in the CA certificates obtained in S703. Then, the controller 400 determines in S1004 whether certification of the signature data has been succeeded in the signature verification in S1003. When it is determined that the certification of the signature data has been failed in the signature verification in S1003, the process proceeds to S1012 described later. When it is determined that the certification of the signature data has been succeeded in the signature verification in S1003, the process proceeds to S1005.

In S1005, the controller 400 analyzes the response data received in S1001 with the encryption processing module 406 and obtains the electronic certificate included in the response data. Next, the controller 400 determines in S1006 whether obtainment of the electronic certificate has been succeeded. When it is determined that the obtainment of the electronic certificate has been failed, the process proceeds to S1012, which will be described later. When it is determined that the obtainment of the electronic certificate has been succeeded, the process proceeds to S1007.

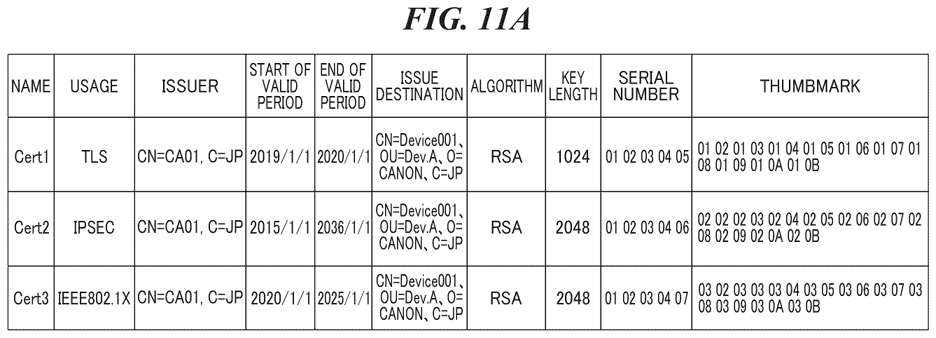

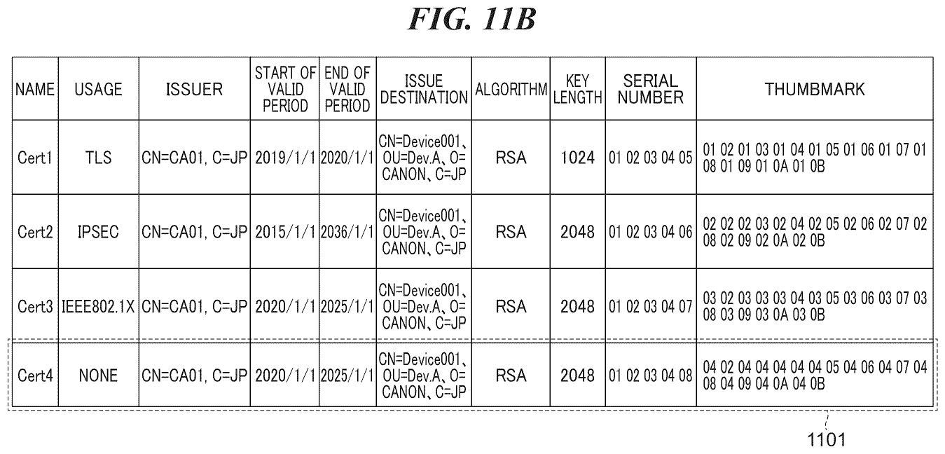

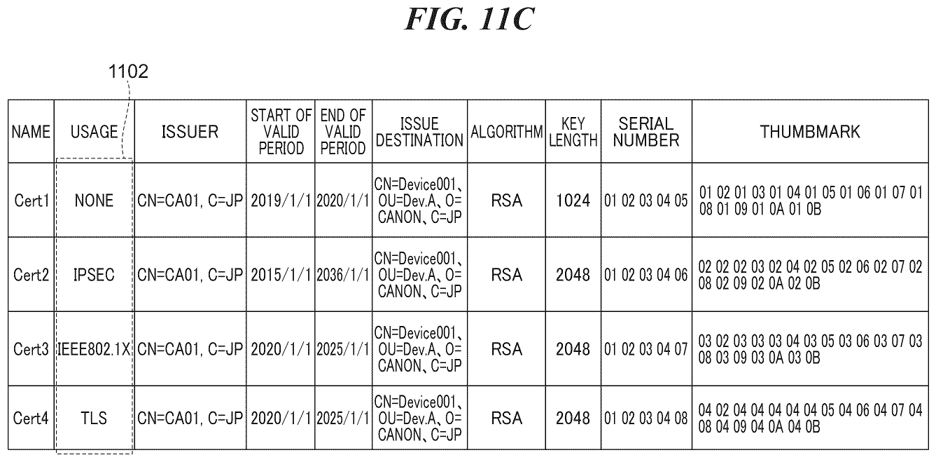

In S1007, the controller 400 performs a registration process to register the obtained electronic certificate. Specifically, the key-pair-and-certificate management module 407 of the controller 400 stores the obtained electronic certificate and the key pair generated in S704 in a predetermined directory in the HDD 304. In the embodiment, the key-pair-and-certificate management unit 407 of the controller 400 manages a database stored in the HDD 304. In the database, pieces of information about electronic certificates and their corresponding key pairs stored in the HDD 304 are recorded (for example, see FIG. 11A). In S1007, the key-pair-and-certificate management unit 407 adds information about the electronic certificate and the key pair stored in the predetermined directory to the database (for example, see 1101 in FIG. 11B). In this way, the obtained electronic certificate is registered as an electronic certificate corresponding to the key pair generated in S704.

Next, the controller 400 determines in S1008 whether the registration of the electronic certificate has been succeeded. When it is determined that the registration of the electronic certificate has been failed, the process proceeds to S1012, which will be described later. When it is determined that the registration of the electronic certificate has been succeeded, the process proceeds to S1009.

In S1009, the controller 400 sets the usage of the electronic certificate based on the set value selected by the key usage check boxes 606 obtained in S702. Here, the usage setting is a communication function using an electronic certificate. In the embodiment, the encrypted communication according to TLS, IPSEC, or IEEE802.1X can be set as the usage of the electronic certificate. The multifunction peripheral 101 in the embodiment can have a plurality of electronic certificates and can set the usages for the respective electronic certificates. For example, the multifunction peripheral 101 uses a first electronic certificate in providing a server service that performs TLS communication as a web server, and uses a second electronic certificate in performing client communication using IEEE802.1X. On the other hand, one electronic certificate may be automatically applied to all communication usages. The key-pair-and-certificate management unit 407 of the controller 400 updates the information about the usage in the database in association with the usage setting of the electronic certificate in S1009 (for example, see 1102 in FIG. 11C). In FIG. 11C, the key pair and the electronic certificate used in the TLS are changed from “Cert1” to “Cert4”.

Next, the controller 400 determines in S1010 whether the usage setting of the electronic certificate has been succeeded. When it is determined that the usage setting of the electronic certificate has been failed, the process proceeds to S1012, which will be described later. When it is determined that the usage setting of the electronic certificate has been succeeded, the process proceeds to S1011.

In S1011, the controller 400 generates HTML data to display a screen shown in FIG. 12A. The screen in FIG. 12A includes a message 1201 indicating that the electronic certificate has been successfully obtained and the reboot button 1202 to instruct rebooting the multifunction peripheral 101. Thereafter, this process is ended.

In S1012, the controller 400 generates HTML data to display a screen shown in FIG. 12B. The screen in FIG. 12B includes a message 1203 indicating that the obtainment of the electronic certificate has been failed. Thereafter, this process is ended.

The above-described processes in S502, S504, S505, S507, and S508 by the multifunction peripheral 101 are controls related to obtainment of an electronic certificate and usage setting of the electronic certificate concerned. Hereinafter, these controls are collectively referred to as an electronic certificate automatic obtaining control. With the electronic certificate automatic obtaining control, the multifunction peripheral 101 can collectively perform the process to transmit the issue request for the electronic certificate to the certification-registration authority 102, the process to obtain the electronic certificate issued by the certification-registration authority 102, and the process to set the usage of the electronic certificate. That is, since the administrator of the multifunction peripheral 101 does not need to separately give execution instructions for these processes, the time and effort of the administrator of the multifunction peripheral 101 can be reduced.

FIG. 13 is a flowchart illustrating procedures of the reboot process executed in S510 in FIG. 5.

As shown in FIG. 13, the controller 400 receives the reboot request in S1301. In the embodiment, as described above, when the administrator of the multifunction peripheral 101 clicks the reboot button 1202 on the screen shown in FIG. 12A displayed on the display unit of the PC 103, the PC103 transmits the reboot request to the multifunction peripheral 101.

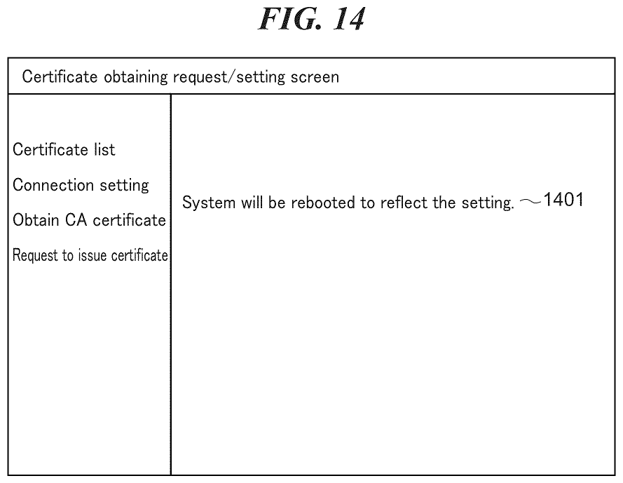

Then, the controller 400 responds to the received reboot request in S1302. Specifically, the controller 400 transmits HTML data to display a screen shown in FIG. 14 to the multifunction peripheral 101 as a response to the received reboot request. The screen in FIG. 14 includes a message 1401 indicating that the multifunction peripheral 101 will be rebooted.

Next, the controller 400 instructs the device control module 410 to start reboot in S1303. When receiving the instruction, the device control module 410 reboots the multifunction peripheral 101. Thereafter, this process is ended. When the above-described reboot process is completed, the electronic certificate obtained from the certification-registration authority 102 becomes available in the multifunction peripheral 101.

The multifunction peripheral 101 in the embodiment assumes that a communication usage such as IEEE802.1X set for an obtained electronic certificate cannot be reflected unless the multifunction peripheral 101 is rebooted. This is because, for example, an electronic certificate such as IEEE802.1X is developed onto the RAM 303 in activating the multifunction peripheral 101 and is continuously used, and thus the electronic certificate stored in the HDD 304 may not be replaced with a new electronic certificate. However, if the multifunction peripheral 101 can switch the electronic certificate used for communication without requiring the reboot, the multifunction peripheral 101 does not have to be rebooted.

According to the first embodiment described above, it is controlled to prevent a date exceeding the imperilment time of the algorithm used for the electronic certificate issuing process from being included in the issue request for the electronic certificate as the expiration date of the electronic certificate. This prevents the date exceeding the imperilment time of the algorithm used for the electronic certificate issuing process from being set as the expiration date of the electronic certificate.

In the first embodiment described above, the algorithm used for the electronic certificate issuing process is the public key encryption algorithm used to generate the key pair. This prevents a date exceeding the imperilment time of the public key encryption algorithm used to generate the key pair from being set as the expiration date of the electronic certificate.

In the first embodiment described above, the algorithm used for the electronic certificate issuing process is the hash algorithm used to generate the key pair. This prevents a date exceeding the imperilment time of the hash algorithm used to generate the key pair from being set as the expiration date of the electronic certificate.

In the first embodiment described above, the control to prevent a date exceeding the imperilment time of the algorithm used for the electronic certificate issuing process from being included in the issue request for the electronic certificate as the expiration date of the electronic certificate is achieved by rewriting the expiration date of the electronic certificate included in the issue request for the electronic certificate to a date one day before the imperilment time of the algorithm. This can reliably prevent a date exceeding the imperilment time of the algorithm used for the electronic certificate issuing process from being set as the expiration date of the electronic certificate.

Although the multifunction peripheral 101 receives an instruction from the PC 103 via the webpage type RUI of the multifunction peripheral 101 and executes the above-described processes in accordance with the instruction in the embodiment, this is not limited. For example, the multifunction peripheral 101 may execute the above-described processes in accordance with an instruction received via a local UI (LUI) using the operation panel 311 of the multifunction peripheral 101 instead of the RUI of the webpage type.

Instead of the administrator of the multifunction peripheral 101 directly and manually operating the RUI of the webpage type, the request may be issued to the multifunction peripheral 101 by automatically inputting and instructing from the PC or another management server by making input fields on a webpage and operation instructions into a template and a rule in advance. In this case, a Web Scraping technique may be used for example.

Although the configuration to determine whether the signature verification is performed based on the set value selected by the signature verification radio buttons 605 is described in the embodiment, this is not limited. For example, the electronic certificate issue request screen in FIG. 6 may not include the signature verification radio buttons 605. In such a case, the signature verification may be always performed or the signature verification may not be performed.

Although the password is included in the certificate signing request in the embodiment, no password may be included in the certificate signing request.

Next, an information processing apparatus and a control method thereof in a second embodiment of the disclosure will be described.

The second embodiment is basically the same as the first embodiment in terms of the configurations and operations and is different from the first embodiment in that the electronic certificate automatic obtaining control is executed when a predetermined time set in advance is reached, instead of an instruction from a user. Therefore, the descriptions about the same configurations and operations will be omitted, and the different configurations and operations will be described below.

In the first embodiment described above, the webpage type RUI is provided to the user of the multifunction peripheral 101 by using the web server function of the multifunction peripheral 101, and the user issues an instruction to the multifunction peripheral 101 via the RUI to automatically issue an electronic certificate and set a usage. The electronic certificate has an expiration date. The electronic certificate of which the expiration date has passed is invalidated, and correct communication certification is not performed, which causes an issue in the network communication. Therefore, when the expiration date of the electronic certificate of the device is approaching or has expired, the electronic certificate is to be updated. However, when there are a plurality of devices that use electronic certificates, it is difficult for an administrator of the devices to update the electronic certificates after understanding the expiration dates of all the electronic certificates.

In contrast, in the second embodiment, the above-described electronic certificate automatic obtaining control is executed when a predetermined time set in advance is reached, instead of an instruction from the user.

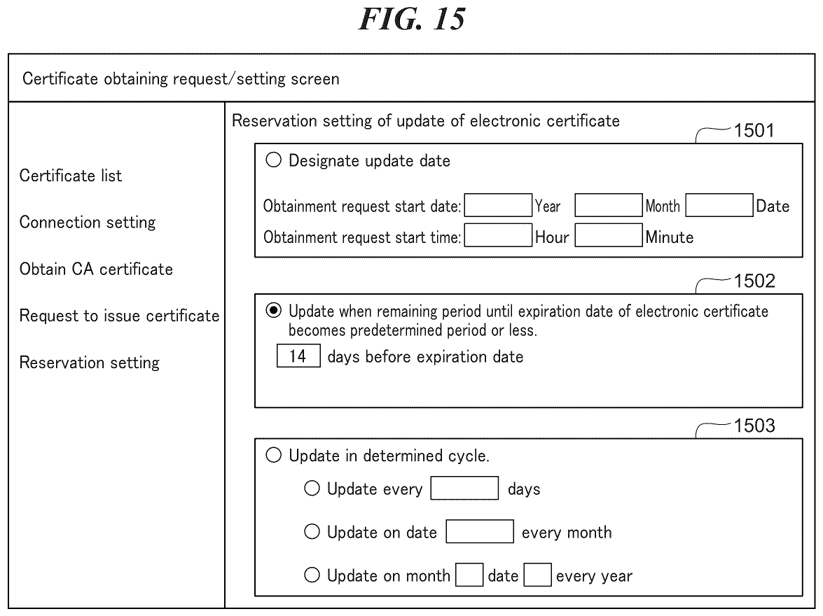

FIG. 15 is a view illustrating an example of an update reservation setting screen in the second embodiment. In the second embodiment, as an example, the update reservation setting screen shall be displayed on the display unit of the PC 103 by the webpage type RUI as with the other screens. The update reservation setting screen may be displayed on the operation panel 311 of the multifunction peripheral 101. An update date of the electronic certificate can be set on the update reservation setting screen. The update reservation setting screen includes three different methods of setting the update date of the electronic certificate, specifically, an update date designation setting 1501, an expiration date designation setting 1502, and a cycle setting 1503.

In the update date designation setting 1501, the update date of the electronic certificate can be designated by year, month, date, and time. When the current date and time held in the multifunction peripheral 101 reaches the date and time set in the update date designation setting 1501, the above-described electronic certificate automatic obtaining control is executed.

In the expiration date designation setting 1502, the update date of the electronic certificate can be designated by the number of days with reference to the expiration date of the electronic certificate. When a remaining period until the expiration date is equal to or less than the designated number of days, the above-described electronic certificate automatic obtaining control is executed.

In the cycle setting 1503, a cycle at which the electronic certificate is updated can be designated. The above-described electronic certificate automatic obtaining control is executed at the designated cycle. In the cycle setting 1503, the number of days indicating the update cycle, a date to be updated in updating every month, or a date to be updated in updating every year can be set. When the set value on the update reservation setting screen is changed, the controller 400 stores the set value set on the update reservation setting screen in the HDD 304.

FIG. 15 is an example of a screen on which the expiration date designation setting 1502 is effective so that the above-described electronic certificate automatic obtaining control is executed when the current date is 14 days before the expiration date. The configuration of the update reservation setting screen is an example, and an item for setting the update date of the electronic certificate by a method different from the above-described method may be included in the update reservation setting screen.

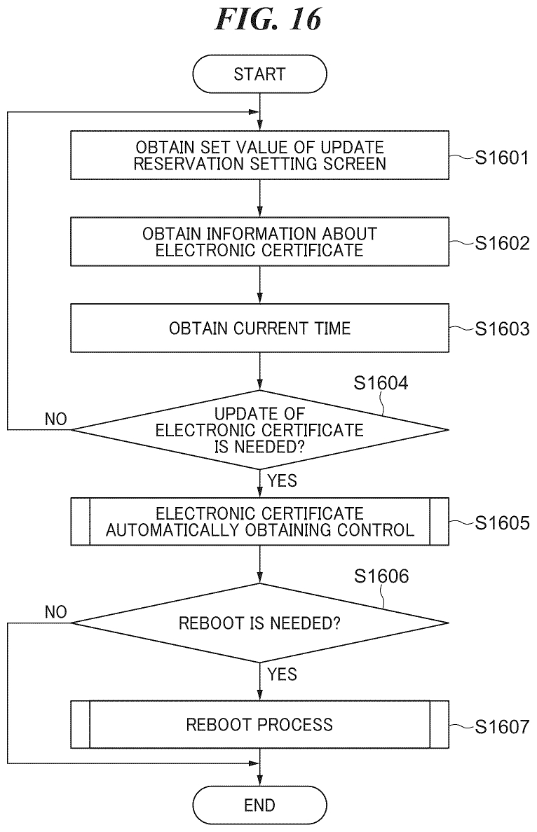

FIG. 16 is a flowchart illustrating procedures of an electronic certificate reservation update control process executed by the multifunction peripheral 101 of FIG. 1. The electronic certificate reservation update control process in FIG. 16 is periodically executed when the multifunction peripheral 101 is activated or at a predetermined time set in advance, for example, at 0:00 a.m. every day.

As shown in FIG. 16, the controller 400 obtains the set value set on the update reservation setting screen from the HDD 304 in S1601.

Next, the controller 400 obtains in S1602 the information about the electronic certificate that is currently used. The information is obtained from the database (for example, see FIG. 11C) that is managed by the key-pair-and-certificate management module 407.

Next, the controller obtains in S1603 the current time of the multifunction peripheral 101. In next S1604, the controller 400 compares the set value on the update reservation setting screen and the information in the electronic certificate to determine whether the electronic certificate that is currently used should be updated. When it is determined that the update of the electronic certificate is not necessary, the process returns to S1601. When it is determined that the update of the electronic certificate is necessary, the process proceeds to S1605.

In S1605, the controller 400 performs the electronic certificate automatic obtaining control described above. Next, the controller 400 determines in S1606 whether the multifunction peripheral 101 is to be rebooted. For example, when the usage setting of the electronic certificate updated by the electronic certificate automatic obtaining control is “IEEE802.1X”, the reboot is performed as described above, and thus it is determined that the reboot of the multifunction peripheral 101 is performed. In this case, the process proceeds to S1607. On the other hand, when the usage setting of the electronic certificate updated by the electronic certificate automatic obtaining control is “TLS”, the reboot is not needed, and thus it is determined that the reboot of the multifunction peripheral 101 is not needed. In this case, this process is ended.

In S1607, the controller 400 performs the above-described reboot process. Thereafter, this process is ended.

In the second embodiment described above, the electronic certificate automatic obtaining control described above is executed when the predetermined time set in advance is reached. That is, the electronic certificate is automatically updated on the designated update date or at the designated update cycle without the administrator of the multifunction peripheral 101 manually giving an instruction. This enables the administrator of the multifunction peripheral 101 to update the electronic certificate at an appropriate timing without taking time and effort even if the administrator does not know the expiration dates of all the electronic certificates. In addition, in the electronic certificate automatic obtaining control, as described above, it is controlled to prevent a date exceeding the imperilment time of the algorithm used for the electronic certificate issuing process from being included in the issue request for the electronic certificate as the expiration date of the electronic certificate. This prevents the expiration date of the updated electronic certificate from exceeding the imperilment time of the algorithm used for the electronic certificate issuing process.

Next, an information processing apparatus and a control method thereof in a third embodiment of the disclosure will be described.

The third embodiment is basically the same as the first embodiment in terms of configurations and operations, and is different from the first embodiment in that a date exceeding the imperilment time is prevented from being included in the issue request for the electronic certificate as the expiration date of the electronic certificate by a method other than setting the expiration date to one day before the imperilment time. Therefore, the descriptions about the same configurations and operations will be omitted, and the different configurations and operations will be described below.

In the first and second embodiments described above, the expiration date is rewritten to be set one day before the imperilment time, thereby preventing a date exceeding the imperilment time from being included in the issue request for the electronic certificate as the expiration date of the electronic certificate.

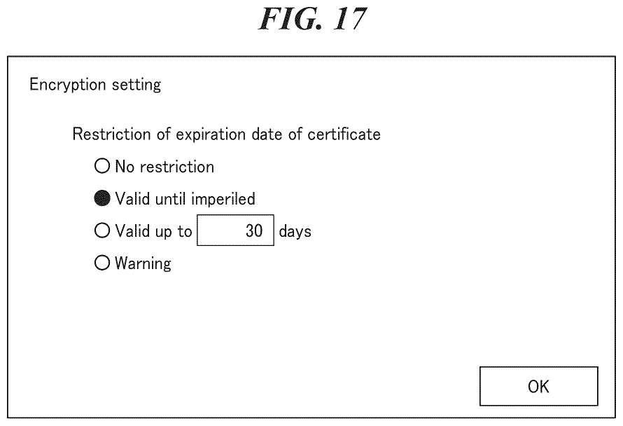

In contrast, in the third embodiment, the control to prevent a date exceeding the imperilment time from being included in the issue request for the electronic certificate as the expiration date of the electronic certificate is switched based on a set value set on a setting screen shown in FIG. 17 by the administrator of the multifunction peripheral 101.

FIG. 17 is a view illustrating an example of the setting screen to set an operation policy applied when the expiration date exceeds the imperilment time. In the third embodiment, this setting screen shall be displayed on the display unit of the PC 103 by a webpage type RUI as with the other screens. The setting screen may be displayed on the operation panel 311 of the multifunction peripheral 101. This setting screen can be operated only by the administrator of the multifunction peripheral 101. In this setting screen, one of four choices can be selected by a radio button.

On this setting screen, “No restriction” as a first choice is selectable. When “No restriction” is selected, the electronic certificate can be used regardless of whether the expiration date of the electronic certificate designated by the administrator of the multifunction peripheral 101 has exceeded the imperilment time of the algorithm used for the electronic certificate issuing process.

In addition, on this setting screen, “Valid until imperiled” as a second choice is selectable. When “Valid until imperiled” is selected, the expiration date is rewritten to a date one day before the imperilment time to control so that a date exceeding the imperilment time is not set as the expiration date of the electronic certificate, as in the first embodiment described above.

In addition, on this setting screen, “Valid up to XX days” as a third choice is selectable. When “Valid up to XX days” is selected, a period during which the electronic certificate is valid can be designated by the number of days from today. Although the number of days is set in a text box in FIG. 17, the number of days may be set by a pull-down menu instead of the text box.

In addition, on this setting screen, “Warning” as a fourth choice is selectable. In a case where “Warning” is selected, when the expiration date of the electronic certificate designated by the administrator of the multifunction peripheral 101 exceeds the imperilment time of the algorithm used for the electronic certificate issuing process, a warning is issued, and the electronic certificate automatic obtaining control is canceled.

The operation of the issue request generation process is switched as follows in accordance with the setting on the setting screen.

In a case where “No restriction” is selected, when it is determined that the connection with the certification-registration authority 102 is succeed in S709 of the issue request generation process, the process ends without performing S710. That is, the expiration date is not rewritten to a date one day before the imperilment time, and the expiration date designated by the administrator of the multifunction peripheral 101 is included in the issue request for the electronic certificate as is.

When “Valid until imperiled” is selected, the process to rewrite the expiration date to a date one day before the imperilment time is performed in the issue request generation process as with the first embodiment described above.

When “Valid up to XX days” is selected, the parameter L is rewritten, in S805 and S809 described above, to a date obtained by adding the number of days input to the text box to the date of performing the process. That is, the number of days obtained by adding the number input in the text box to the date of performing the process is set in the issue request for the electronic certificate as the expiration date of the electronic certificate.

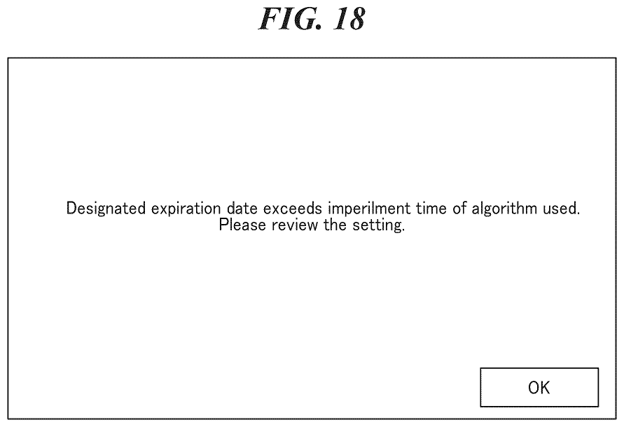

In a case where “Warning” is selected, when it is determined in S804 that the parameter L exceeds the first imperilment time, the process does not proceed to S805 and the error handling is performed, and when it is determined in S808 that the parameter L exceeds the second imperilment time, the process does not proceed to S809 and the error handling is performed. In the error handling, the multifunction peripheral 101 transmits HTML data to display an error screen shown in FIG. 18 to the PC 103. This screen includes a message indicating that the designated expiration date exceeds the imperilment time of the algorithm used for the electronic certificate issuing process. Also, the electronic certificate automatic obtaining control is aborted. That is, the issue request for the electronic certificate is not transmitted to the certification-registration authority 102. By controlling in this manner, it is possible to prevent issue of an electronic certificate of which an expiration date exceeding the imperilment time of the algorithm used for the electronic certificate issuing process.

In the third embodiment described above, the control to prevent a date exceeding the imperilment time from being included in the issue request for the electronic certificate as the expiration date of the electronic certificate is switched based on the set value set on the setting screen shown in FIG. 17 by the administrator of the multifunction peripheral 101. Accordingly, an intention of the user can be reflected to the control.

According to the disclosure, it is possible to prevent a date exceeding the imperilment time of the algorithm used for the electronic certificate issuing process from being set as the expiration date of the electronic certificate.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-099542, filed Jun. 20, 2024, which is hereby incorporated by reference herein in its entirety.

What is claimed is:

1. An apparatus comprising:
a memory device that stores a set of instructions; and
at least one processor that executes the set of instructions to:
generate a key pair;
generate an issue request for an electronic certificate that certifies legitimacy of the apparatus according to an instruction by a user, the issue request including a certificate signing request generated based on a public key included in the generated key pair;
perform control to prevent a date exceeding an imperilment time of an algorithm used for an issue process for an electronic certificate from being included in the issue request as an expiration date of the electronic certificate; and
obtain an electronic certificate generated according to the issue request.

2. The apparatus according to claim 1, wherein the algorithm is a public key encryption algorithm used to generate the key pair.

3. The apparatus according to claim 1, wherein the algorithm is a hash algorithm used to generate the key pair.

4. The apparatus according to claim 1, wherein the perform control is performed by rewriting the expiration date of the electronic certificate included in the issue request to a date one day before the imperilment time of the algorithm.

5. The apparatus according to claim 1, wherein the perform control is performed by stopping transmission of the issue request to a certificate authority that issues the electronic certificate and warning that a date designated as an expiration time of the electronic certificate exceeds the imperilment time of the algorithm.

6. The apparatus according to claim 4, wherein the at least one processor executes the set of instructions to switch the control based on a set value set by the user.

7. The apparatus according to claim 5, wherein the at least one processor executes the set of instructions to switch the control based on a set value set by the user.

8. The apparatus according to claim 4, wherein the at least one processor executes the set of instructions to:
read a document and generate image data of the document;
generate a signature using a secret key included in the key pair generated; and
add the signature and the electronic certificate to the image data of the document.

9. The apparatus according to claim 1, further comprising a printer.

10. A method for an apparatus, the method comprising:
generating a key pair;
generating an issue request for an electronic certificate that certifies legitimacy of the apparatus according to an instruction by a user, the issue request including a certificate signing request generated based on a public key included in the key pair generated;
performing control to prevent a date exceeding an imperilment time of an algorithm used for an issue process for an electronic certificate from being included in the issue request as an expiration date of the electronic certificate; and
obtaining an electronic certificate generated according to the issue request.

11. The method according to claim 10, wherein the algorithm is a public key encryption algorithm used to generate the key pair.

12. The method according to claim 10, wherein the algorithm is a hash algorithm used to generate the key pair.

13. The method according to claim 10, wherein the performing control is performed by rewriting the expiration date of the electronic certificate included in the issue request to a date one day before the imperilment time of the algorithm.

14. The method according to claim 10, wherein the performing control is performed by stopping transmission of the issue request to a certificate authority that issues the electronic certificate and warning that a date designated as an expiration time of the electronic certificate exceeds the imperilment time of the algorithm.

15. A non-transitory computer-readable storage medium storing a program causing a computer to execute a method for an apparatus, the method comprising:
generating a key pair;
generating an issue request for an electronic certificate that certifies legitimacy of the apparatus according to an instruction by a user, the issue request including a certificate signing request generated based on a public key included in the key pair generated;
performing control to prevent a date exceeding an imperilment time of an algorithm used for an issue process for an electronic certificate from being included in the issue request as an expiration date of the electronic certificate; and
obtaining an electronic certificate generated according to the issue request.

16. The non-transitory computer-readable storage medium according to claim 15, wherein the algorithm is a public key encryption algorithm used to generate the key pair.

17. The non-transitory computer-readable storage medium according to claim 15, wherein the algorithm is a hash algorithm used to generate the key pair.

18. The non-transitory computer-readable storage medium according to claim 15, wherein the performing control is performed by rewriting the expiration date of the electronic certificate included in the issue request to a date one day before the imperilment time of the algorithm.

19. The non-transitory computer-readable storage medium according to claim 15, wherein the performing control is performed by stopping transmission of the issue request to a certificate authority that issues the electronic certificate and warning that a date designated as an expiration time of the electronic certificate exceeds the imperilment time of the algorithm.
